(19) United States
(12) Patent Application Publication
(10) Pub. No.: US 2005/0116207 A1
(43) Pub. Date: Jun. 2, 2005

(54) Multi-photon absorber medium and method of exposure using the same

(75) Inventor: Takeharu Tani, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/936,805

(22) Filed: Sep. 9, 2004

(30) Foreign Application Priority Data
Sep. 11, 2003 (JP) 319736/2003

(51) Int. Cl. G01T 3/06

(52) U.S. Cl. 252/501.1

(57) ABSTRACT

A multi-photon absorber medium is of a predetermined thickness and contains multi-photon absorber material. The medium causes photo-reaction by multi-photon absorption upon receipt of light projected inward from one side. The reactivity to the light of the medium gradually increases from the one side toward another side.

### BACKGROUND OF THE INVENTION

1. Field of the Invention

This invention relates to a method of exposing a recording medium or the like by the use of two-photon or multi-photon absorption which is a nonlinear optical effect, and to a multi-photon absorber to be used in the method.

2. Description of the Related Art

Though light absorption in material is ordinarily a phenomenon where one photon is absorbed by the material, multi-photon absorption where two or more photons are simultaneously absorbed by the material occurs when exposed to high-power light such as an ultrashort-pulsed laser beam. In the case of two-photon absorption (two photons are simultaneously absorbed), the material receives energy twice the ordinaries. Accordingly, exposure of the material which ordinarily absorbs light having a wavelength of λ to high-power light having a wavelength of 2λ (that is, 1/2 in energy) can cause reaction equivalent to that obtained when the material is exposed to light having a wavelength of λ.

Since the multi-photon absorption including the two-photon absorption is a phenomenon where probability that the material absorbs the photon increases in direct proportion to the photon density, it is possible to selectively cause the multi-photon absorption only in the vicinity of the focus position where the light is focused and the maximum of the photon density causes from exposing the focused light to the material. Accordingly, when a recording medium is formed of multi-photon absorber material which causes a photo-isomerization such as a phase change, a refractive index change or a chemical change by multi-photon absorption and the recording medium is exposed to focused light, information can be recorded in multiple layers in the recording medium by changing the focus position of the recording focused light, e.g., by scanning the recording medium with recording focused light which is focused at a constant focus position in the direction of depth of the recording medium (in the direction of travel of the recording focused light) and then changing the focus position of the recording focused light. In U.S. patent Laid-Open No. 20010001607, there is disclosed an apparatus for recording information on such a multi-photon absorber recording medium in multiple layers by scanning the recording medium with recording focused light.

On the other hand, there has been proposed a method in which a multi-photon absorber medium which exhibits photopolymerization is three-dimensionally photo-imaged by three-dimensionally exposing the medium to focused light on the basis of the fact that the multi-photon absorption can be selectively caused only in the vicinity of the focus position of the focused light. In “Three-dimensional Microfabrication with Two-photon-absorbed Photopolymerization” by Shoji Maruo, et al., (OPTICS LETTERS, vol. 22, No. 2 Jan. 15, 1997, pp. 132-134) and “Two-photon-absorption Optical-fabrication with a Micro-lens Array” by Yoshihiro Adachi et al., (Extended Abstracts for The 50th Spring Meeting, 2003; The Japan Society of Applied Physics and Related Societies, 27p-YN-4, March 2003) there have been disclosed examples of the apparatus for three-dimensionally photo-imaging such a multi-photon absorber medium in the manner described above. Especially in the latter paper, there has been disclosed a photo-imaging method in which a single laser beam is branched into a plurality of laser beams by a micro-lens array, and the branched laser beams are respectively focused and used to image a plurality of three-dimensional models in parallel.

Further, in the latter paper, there have been disclosed examples of the multi-photon absorber medium which are large in two-photon absorption cross-sectional area and preferable. In order to make such multi-photon absorber media applicable to the photo-imaging described above, for instance, they are made to contain photo-setting resin.

Conventionally, there has been a problem that executing three-dimensional information recording or three-dimensional photo-imaging by exposure of multi-photon absorber media causes underexposure or overexposure since the degree of reaction to light of the multi-photon absorber medium changes depending upon the position of the multi-photon absorber medium in the direction of depth.

### SUMMARY OF THE INVENTION

In view of the foregoing observations and description, the primary object of the present invention is to provide a method of exposing a multi-photon absorber medium which can excellently expose the multi-photon absorber medium irrespective of its position in the direction of depth.

Another object of the present invention is to provide a multi-photon absorber medium to be used in carrying out the method.

In accordance with the present invention, there is provided a multi-photon absorber medium of a predetermined thickness which contains therein multi-photon absorber material and causes photo-reaction by multi-photon absorption upon receipt of light projected inward from one side thereof wherein the improvement comprises that the reactivity to the light gradually increases from said one side toward another side.

The reactivity to the light can be changed in the manner described above by changing the light absorbing efficiency of the multi-photon absorber material, for instance, by changing the concentration thereof. Or in the case of a multi-photon absorber medium in which multi-photon absorber material and a polymerization initiator are mixed with each other, it is possible to change the reactivity to light of the multi-photon absorber medium in the manner described above by changing the concentration of the polymerization initiator without changing the light absorbing efficiency of the multi-photon absorber material.

It is preferred that the multi-photon absorber medium causes at least one of photopolymerization, photo-isomerization and photo-decomposition by multi-photon absorption.

In accordance with the present invention, there is provided a method of exposure by multi-photon absorption characterized by projecting light inward from one side of a multi-photon absorber medium described above to be focused in a predetermined position, thereby exposing the multi-photon absorber medium.

Our investigation reveals that the problem that the degree of reaction to light of the multi-photon absorber medium changes depending upon the position of the multi-photon absorber medium in the direction of depth is caused due to that the exposure light is scattered and absorbed by the multi-photon absorber medium before it reaches the focus position as well as that the focus spot at which the exposure light is focused is enlarged due to aberration. That is, the degree of such a phenomenon increase as the focus position becomes deeper. Conventionally, photo-reaction is less apt to occur as the focus position becomes deeper since the exposing conditions are unchanged irrespective of the depth of the focus position. The multi-photon absorber medium of this invention is formed so that the reactivity to the exposure light gradually increases from one side toward another side on the basis of said recognition. When projecting light inward from one side of the multi-photon absorber medium, that photo-reaction is less apt to occur as the focus position becomes deeper is compensated for by increase in the reactivity of the medium and the degree of photo-reaction is substantially uniformed in the direction of depth of the multi-photon absorber medium.

### BRIEF DESCRIPTION OF THE DRAWINGS

FIG. 1 is a schematic side view showing an apparatus employing a multi-photon absorber medium in accordance with an embodiment of the present invention.

### DESCRIPTION OF THE PREFERRED EMBODIMENT

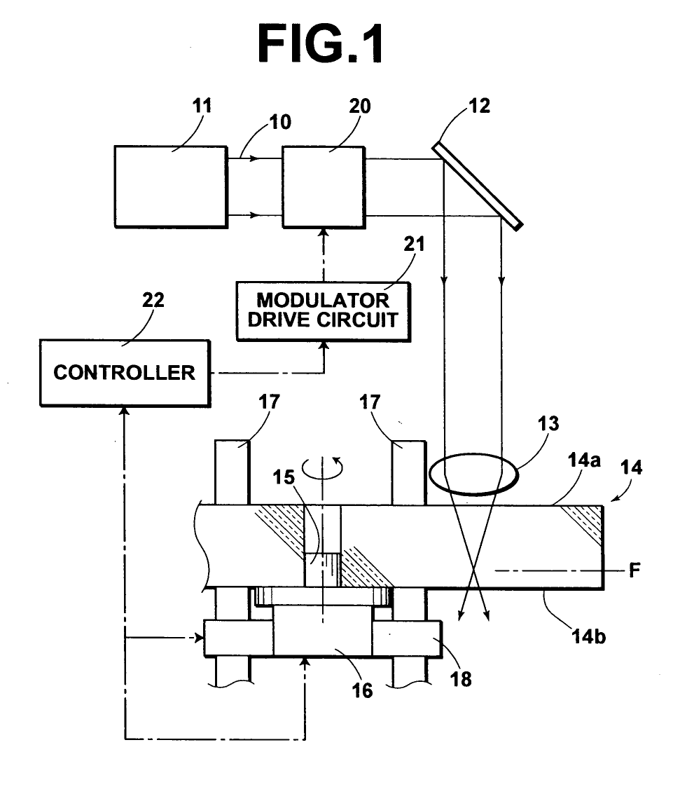

In FIG. 1, a multi-photon absorption exposure apparatus employing a multi-photon absorber medium in accordance with an embodiment of the present invention is for recording information in the optical disc in multiple layers. As shown in FIG. 1, the apparatus comprises a pulsed laser 11 which emits a pulsed light beam 10 as the exposure light, a mirror 12 which folds the optical path of the pulsed light beam 10 by 90° a collective lens 13 which converges the pulsed light beam 10 reflected at the mirror 12, an optical disc drive means 16 provided with a spindle 15 which holds and rotates an optical disc 14 and an up-and-down means 18 which holds the optical disc drive means 16 and moves the same up and down along a pair of guide members 17.

The multi-photon absorption exposure apparatus is further provided with an optical modulator 20 such as an AOM (acousto-optic modulator), a modulator drive circuit 21 which drives the modulator 20, a controller 22 which may comprise a computer system and controls the modulator drive circuit 21, the optical disc drive means 16 and the up-and-downmeans 18. The optical modulator 20can continuously change the amount of the pulsed light beam 10 transmitted therethrough, for instance, from 0 to 100% as well as can turn on and off the pulsed light beam 10.

The pulsed laser 11 comprises, for instance, a Ti:sapphire laser. In this particular embodiment, the pulsed laser 11 is 1 W, 780 nm, 82 MHz, and 100 fs (femtosecond) in the mean output power, the oscillation wavelength, the pulse repetition rate and the pulse width. Further, the collective lens 13 is 0.7 in the NA (numerical aperture) and 100× in the magnification.

The optical disc 14 is of material formed by mixing two-photon absorber material, polymerization initiator and photopolymer and the concentration of the two-photon absorber material gradually increases from one side 14a of the optical disc 14 to the other side 14b. Preferably the two-photon absorber material is one of those which are disclosed in U.S. patent Laid-Open No. 20030052311 and large in two-photon absorption cross-sectional area. Preferred photopolymer is SCR-701 from D-Mec Ltd. disclosed in U.S. patent Laid-Open No. 20030052311.

When the exposure light is projected onto the optical disc 14 with the photon density kept very high, the two-photon absorber material causes the two-photon absorption and the absorbed light energy is transferred to the polymerization initiator, whereby the photopolymer causes photopolymerization. In the part where the photopolymerization is caused, the photopolymer density increases and the refractive index increases. Accordingly, information can be recorded in the optical disc 14 in the form that whether there is a change of refractive index.

When information is to be recorded with this apparatus, the up-and-down means 18 is moved up and down to hold the optical disc 14 in a predetermined vertical position. Then the pulsed laser 11 is driven and the disc drive means 16 rotates the optical disc 14. At this time, the controller 22 controls the modulator drive circuit 21 according to the information to be recorded S1 to turn on and off the pulsed light beam 10 according to the information to be recorded S1.

The modulated pulsed light beam 10 is reflected by the mirror 12 to impinge upon the optical disc 14 from said one side 14a thereof and is focused inside the optical disc 14 by the collective lens 13. Since being rotated in the predetermined vertical position, the optical disc 14 is scanned by the pulsed light beam 10 along an arcuate recording track.

Since being very short (100 fs), the pulsed light beam 10 is very high in the photon density in the focus position F and in the vicinity thereof. Accordingly, only in the focus position F and in the vicinity thereof, the optical disc 14 causes the two-photon absorption and photopolymerization occurs in the optical disc 14 in a manner similar to when ultraviolet light having a wavelength of 390 nm (=780 nm/2) is absorbed and the refractive index increases. Since the pulsed light beam 10 is modulated according to the information to be recorded S1, information can be recorded in the optical disc 14 in the form that whether there is a change of refractive index.

After the information is recorded along a predetermined recording track in a plane of the optical disc 14 along the focus position F of the pulsed light beam 10 and the optical disc 14 is moved in a diametrical direction of the optical disc 14 by a horizontal movement means (not shown) so that information is two-dimensionally recorded in the plane of the optical disc 14 along the focus position F of the pulsed light beam 10, the up-and-down means 18 finely moves the disc drive means 16, and accordingly, the optical disc 14, in the direction of rotating axis thereof (in the vertical direction). In this state, the optical disc 14 is two-dimensionally scanned by the modulated pulsed light beam 10 in the manner described above. By repeating the two-dimensional scanning by the pulsed light beam 10 and the movement of the optical disc 14 in the direction of the rotating axis in this manner, information is recorded in the optical disc 14 in multiple layers.

As described above, the pulsed light beam 10 is scattered and absorbed by the optical disc 14 before it reaches the focus position F and the focus spot at which the exposure light is focused is enlarged due to aberration. The degree of such a phenomenon increase as the focus position F becomes deeper. Accordingly, if the exposing conditions are unchanged irrespective of the depth of the focus position F, photo-reaction is less apt to occur as the focus position F becomes deeper.

Whereas, in the optical disc 14, since the concentration of the two-photon absorber material increases from said one side 14a to the other side 14b of the optical disc 14, that photo-reaction is less apt to occur as the focus position F becomes deeper is compensated for by change of the photo-reactivity of the optical disc 14 itself and the degree of photo-reaction is substantially uniformed in the direction of depth of the optical disc 14. Accordingly, in the exposure apparatus of this embodiment, exposure can be constantly adequate without underexposure or overexposure.

The photo-reactivity of the optical disc 14 can be distributed as described above by changing the concentration of the polymerization initiator so that it gradually increases from said one side 14a to the other side 14b without changing the light absorbing efficiency of the two-photon absorber material instead of changing the light absorbing efficiency by changing the concentration of the two-photon absorber material.

Controls for demonstrating the above effect will be described, hereinbelow. As a first control, an optical disc which was uniform in multi-photon absorber material concentration in the direction of thickness thereof was prepared, and exposing conditions were set to be optimal in the vicinity of the surface of the optical disc. The exposing conditions were fixed and the optical disc was three-dimensionally exposed under the fixed exposing conditions. The optimal exposing conditions were as follows. The mean output power of the exposure light: 10 mW. The exposure time for photopolymerization of one point: 1 ms. In this case, as the focus position F became deeper, underexposure was caused. Typically, when the focus position exceeded 300 μm, it became impossible to increase the refractive index of the optical disc.

Then, as a second control, an optical disc which was uniform in multi-photon absorber material concentration in the direction of thickness thereof was prepared, and exposing conditions were set to be optimal at a depth of 300 μm of the optical disc. The exposing conditions were fixed and the optical disc was three-dimensionally exposed under the fixed exposing conditions. The optimal exposing conditions were as follows. The mean output power of the exposure light: 20 mW. The exposure time for photopolymerization of one point: 1 ms. In this case, when the focus position F was on said one side, overexposure was caused and deterioration in resolution and/or boiling of the optical disc due to local heat absorption could be caused.

On the other hand, in accordance with this embodiment, adequate exposure could be realized irrespective of the depth of the optical disc in the region from the vicinity of said one side 14a of the optical disc 14 to a depth of 1 mm.

An adequate two-photon absorber material concentration in the optical disc 14 in the direction of thickness thereof can be obtained, for instance, in the following manner. Ten types of optical discs which differ from each other in two-photon absorber material concentration, for instance, by 0.1 weight % in the range from 0.1 wt % to 1.0 wt % are prepared. In each of these optical discs, the two-photon absorber material concentration is uniform in the direction of thickness. The exposing conditions to the ten types of optical discs are fixed so that the mean output power of the exposure light is 300 mW and the exposure time for photopolymerization of one point is 1 μs, and the optical discs are exposed while changing the depth of the focus position. Then, the type of the most adequately exposed optical disc is determined by the depth of the focus position and the two-photon absorber material concentration of the type is investigated, whereby the two-photon absorber material concentration which can realize a most adequate exposure can be known by the depth of the focus position.

After the two-photon absorber material concentration which is optimal to the depth is thus obtained by the depth of the focus position, an optical disc in which the two-photon absorber material concentration is distributed according to the relation between the depth of the focus position and the two-photon absorber material concentration is made. Such an optical disc 14 can be made by repeating spin-coating of material while changing the two-photon absorber material concentration in the material.

Though the optical disc 14 in the embodiment described above exhibits photopolymerization by the multi-photon absorption, the present invention can be applied to multi-photon absorber medium which exhibits photo-reaction other than the photopolymerization such as photo-isomerization and photo-decomposition by multi-photon absorption.

Further, though applied to information recording in the embodiment described above, the present invention can be applied also to three-dimensional modeling or the like with similar effects.

1. A multi-photon absorber medium of a predetermined thickness which contains therein multi-photon absorber material and causes photo-reaction by multi-photon absorption upon receipt of light projected inward from one side thereof wherein the improvement comprises that the reactivity to the light gradually increases from said one side toward another side.

2. A multi-photon absorber medium as defined in claim 1 in which the reactivity to the light is changed by changing the concentration of the multi-photon absorber material.

3. A multi-photon absorber medium as defined in claim 1 in which the multi-photon absorber medium causes at least one of photopolymerization, photo-isomerization and photo-decomposition by multi-photon absorption.

4. A method of exposure by multi-photon absorption characterized by projecting light inward from one side of a multi-photon absorber medium as defined in claim 1 to be focused in a predetermined position, thereby exposing the multi-photon absorber medium.

5. A method of exposure by multi-photon absorption as defined in claim 4 in which the multi-photon absorber medium is as defined in claim 2.

6. A method of exposure by multi-photon absorption as defined in claim 4 in which the multi-photon absorber medium is as defined in claim 3.
